(19) United States
(12) Patent Application Publication
(10) Pub. No.: US 2001/0016304 A1
(43) Pub. Date: Aug. 23, 2001

(54) Colour photographic silver halide material

(76) Inventors: Jorg Hagemann, Koln (DE); Jan Haller, Leverkusen (DE); Gunter Helling, Odenthal (DE)

Correspondence Address: Connolly Bove Lodge & Hutz LLP, P.O. Box 2207, Wilmington, DE, 19899-2207, US

(21) Appl. No.: 09/734,634

(22) Filed: Dec. 12, 2000

(30) Foreign Application Priority Data
Dec. 17, 1999 (DE) 199 60 899 . 7

(51) Int. Cl. G03C 1/46; G03C 7/26; G03C 7/32; G03C 7/34; G03C 1/43

(52) U.S. Cl. 430/553; 430/558; 430/505

(57) ABSTRACT

A color photographic silver halide material having a support and at least one photosensitive silver halide emulsion layer which is associated with a cyan coupler of the formula (I):

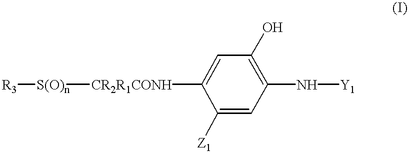

in which

R₁, R₂, R₃, Z₁, Y₁ and n have the meaning stated in the description,

is distinguished by elevated dye stability of the dye produced from the coupler by chromogenic processing.

This invention relates to a colour photographic silver halide material having a novel cyan coupler.

It is known from JP-N 59 111 645, U.S. Pat. No. 5,008,180 and U.S. Pat. No. 5,686,235 to use 2,5-diacylaminophenols having a sulfonyl group as cyan couplers. However, the colour reproduction and dye stability of the dyes produced from the couplers by chromogenic processing do not meet requirements.

The object of the invention was to provide cyan couplers which are improved with regard to these properties. This object is achieved with the couplers described below.

The present invention accordingly provides a colour photographic silver halide material having a support and at least one photosensitive silver halide emulsion layer which is associated with a cyan coupler of the formula (I):

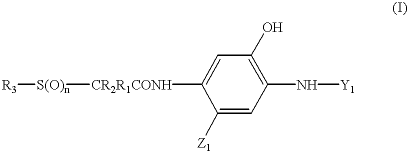

in which

R₁, R₂ mean H, alkyl, alkenyl, aryl or hetaryl,

R₃ means alkyl, alkenyl, aryl or hetaryl,

Z₁ means H or a group eliminable under the conditions of chromogenic development,

Y₁ means —COR₄, —CO₂R₄, —CONR₄R₅, —SO₂R₄, —SO₂NR₄R₅, —CO—CO₂R₄, —COCONR₄R₅ or a group of the formula

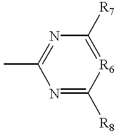

R₄ means alkyl, alkenyl, aryl or hetaryl,

R₅ means H or R₄,

R₆ means —N═ or —C(R₉)═

R₇, R₈, R₉ mean —OR₅, —SR₅, —NR₄R₅, —R₅ or Cl and

n means 1 or 2.

Within the formula, the following groups of couplers are preferred:

(1) couplers in which n means 1 and R₁ to R₉, Z₁ and Y₁ have the stated meaning.

(2) couplers in which n means 2, Y₁ means —CO—Y₁₁ and Y₁₁ means alkenyl or hetaryl and R₁ to R₃ and Z₁ have the stated meaning.

(3) couplers in which n means 2, Y₁ means —SO₂R₁₀, —SO₂N(R₁₀)₂, —CO₂R₁₀, —COCO₂—R₁₀ or —COCO—N(R₁₀)₂ and R₁₀ means alkyl, aryl, alkenyl or hetaryl and

R₁ to R₃ and Z₁ have the stated meaning.

(4) couplers in which n means 2, Y₁ means a residue of the formula

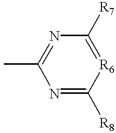

and R₁ to R₃, R₆ to R₈ and Z₁ have the stated meaning.

(5) couplers in which n means 2, Y₁ means a residue of the formula

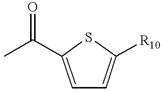

wherein

R₁₀ means H, Cl, CN, Br, F, alkylcarbonyl, arylcarbonyl, alkylaminocarbonyl, arylaminocarbonyl, alkoxycarbonyl or aryloxycarbonyl and R₁ to R₃ and Z₁ have the stated meaning.

In the formula (I) and the compounds (1) to (4), the substituents have the following preferred meaning:

R₁, R₂H, alkyl, aryl,

R₃ alkyl, aryl,

Z₁ H, Cl, alkoxy, aryloxy, alkylthio, arylthio,

R₆ —N═,

R₇, R₈—OR₅, —NR₄R₅, —Cl.

Very particularly preferably,

R₂ means H and

R₄ means alkyl or aryl.

Alkyl and alkenyl residues may be linear, branched or cyclic and in turn be substituted.

Aryl and hetaryl residues may in turn be substituted, wherein aryl is in particular phenyl.

Possible substituents for the alkyl, alkenyl, aryl or hetaryl residues are: alkyl, alkenyl, aryl, hetaryl, alkoxy, aryloxy, alkenyloxy, hydroxy, alkylthio, arylthio, halogen, cyano, acyl, acyloxy, acylamino, wherein an acyl residue may be derived from an aliphatic, olefinic or aromatic carbonic, carboxylic, carbamic, sulfonic, sulfonamido, sulfinic, phosphoric, phosphonic or phosphorous acid.

Examples of compounds according to the invention in which n=2 are:

| Nr. | R₁ | R₂ | R₃ | Y₁ | Z₁ |
|---|---|---|---|---|---|
| I-1 | —C₂H₅ | H | 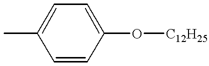 | 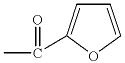 | —Cl |
| I-2 | —C₂H₅ | H | 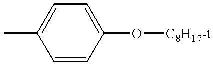 | 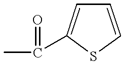 | —H |
| I-3 | —C₆H₁₃ | H | 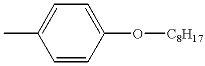 | 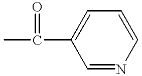 | —OCH₂CH₂—SCH₂COOH |
| I-4 | -phenyl | H | 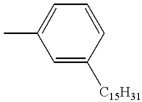 | 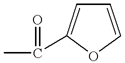 | —Cl |
| I-5 | —CH₃ | —CH₃ | —C₁₆H₃₃ | 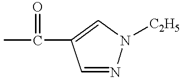 | —Cl |
| I-6 | -phenyl | H | —C₁₂H₂₇ | 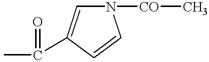 | —SCH₂CH₂—COOH |
| I-7 | —C₂H₅ | H | 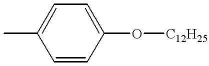 | 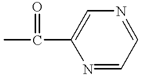 | —O—CH₂—COOCH₃ |
| I-8 | C₁₂H₂₅ | H | 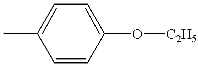 | 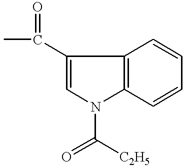 | —Cl |
| I-9 | —C₃H₇-i | H | 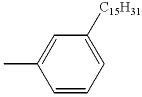 | 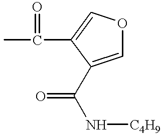 | —Cl |
| I-10 | —CH₃ | —CH₃ | 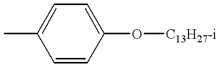 | 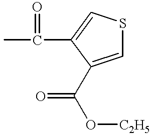 | 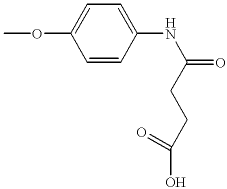 |
| I-11 | —C₂H₅ | H | 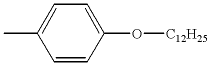 | 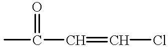 | —Cl |
| I-12 | -phenyl | H | —C₁₆H₃₃ | 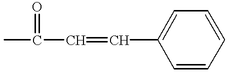 | H |
| I-13 | —C₁₂H₂₅ | H | 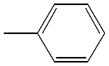 | 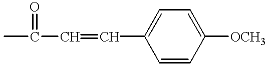 | —Cl |
| I-14 | —C₄H₉ | H | 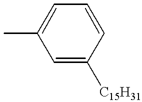 | 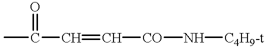 | —OCH₂COOCH₃ |
| I-15 | —CH₃ | —CH₃ | 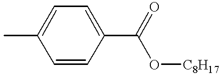 | 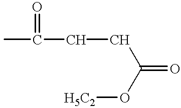 | —Cl |
| I-16 | —C₂H₅ | H | 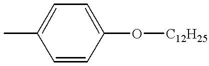 | —SO₂—C₄H₉ | —Cl |
| I-17 | —C₂H₅ | H | 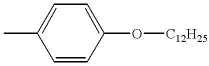 | —CO—O—C₄H₉-i | —Cl |
| I-18 | —C₃H₇-i | H | 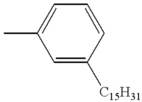 | 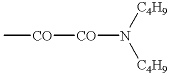 | —OCH₂—COOCH₃ |
| I-19 | -phenyl | H | 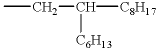 | —SO₂—NH—C₄H₉-t | H |
| I-20 | —C₆H₁₃ | H | 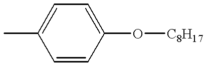 | 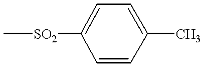 | H |
| I-21 | —CH₃ | —CH₃ | 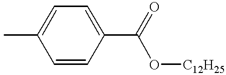 | —CO—CO—OC₂H₅ | —Cl |
| I-22 | —C₄H₉ | H | 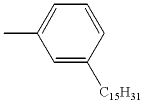 | —SO₂—CH₃ | —Cl |
| I-23 | -phenyl | -phenyl | —C₁₂H₂₅ | —SO₂C₄H₉ | —SCH₂CH₂—COOH |
| I-24 | —C₁₂H₂₅ | H | 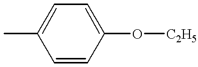 | —CO—O—C₂H₅ | —Cl |
| I-25 | —C₂H₅ | H | 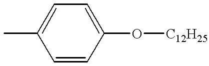 | 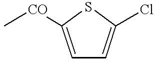 | Cl |
| I-26 | —CH₃ | H | 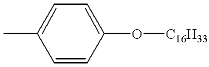 | 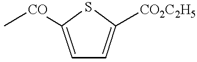 | Cl |
| I-27 | —C₂H₅ | H | 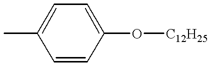 | 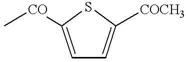 | Cl |

Examples of compounds according to the invention in which n = 2 and

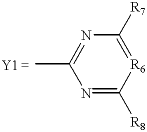

are:

| No. | R₁ | R₂ | R₃ | R₇ | R₈ | R₆ | Z₁ |
|---|---|---|---|---|---|---|---|
| I-28 | —C₂H₅ | H | 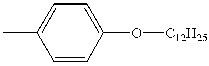 | —N(C₄H₉)₂ | —N(C₄H₉)₂ | —N═ | —C— |
| I-29 | —C₂H₅ | H | 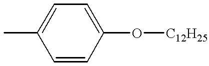 | 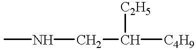 | 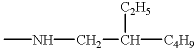 | —N═ | —Cl |
| I-30 | —C₂H₅ | H | 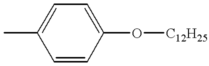 | —OCH₃ | —OCH₃ | —N═ | —Cl |
| I-31 | —C₆H₁₃ | H | 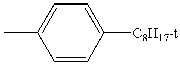 | —Cl | —NH—C₄H₉ | —C(NHC₄H₉)═ | H |
| I-32 | -phenyl | H | —C₁₂H₂₅ | —OCH₃ | —N(C₄H₉)₂ | —N═ | —OCH₂COOCH₃ |
| I-33 | —CH₃ | —CH₃ | 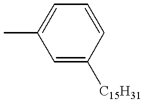 | —NH—C₄H₉ | —NH—C₄H₉ | —C(N(C₂H₅)₂)═ | —Cl |
| I-34 | H | H | 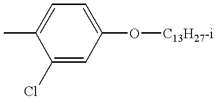 | —OCH₃ | —NH—C₄H₉ | —N═ | —S—CH₂CH₂—COOH |
| I-35 | —CH₃ | H | 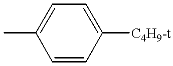 | —Cl | 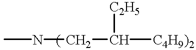 | —N═ | —Cl |

Compounds according to the invention in which n = 1 are:

| No. | R₁ | R₂ | R₃ | Y₁ | Z₁ |
|---|---|---|---|---|---|
| I-36 | —C₂H₅ | H | 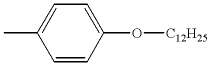 | 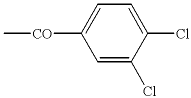 | —Cl |
| I-37 | —C₄H₉ | H | 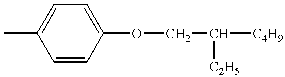 | —CO—C₃H₇ | —Cl |
| I-38 | —C₆H₁₃ | H | 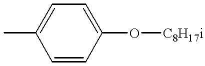 | 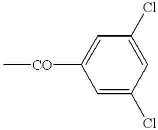 | —OCH₂CH₂—S—CH₂COOH |
| I-39 | —CH₃ | —CH₃ | 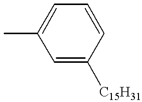 | 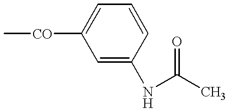 | H |
| I-40 | -phenyl | H | 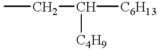 | 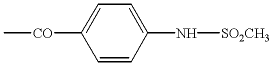 | —Cl |
| I-41 | —C₂H₅ | H | 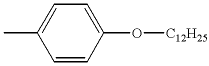 | 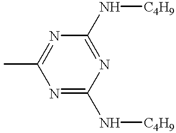 | H |
| I-42 | —C₁₂H₂₅ | H | 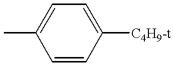 | 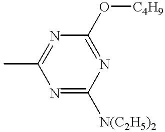 | 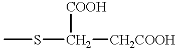 |
| I-43 | —C₄H₉ | H | —C₁₂H₂₅ | 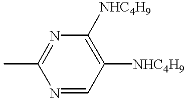 | —Cl |
| I-44 | —C₂H₅ | H | 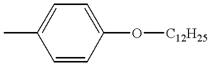 | —SO₂—C₄H₉ | —Cl |
| I-45 | —C₃H₇-i | H | —C₁₆H₃₃ | 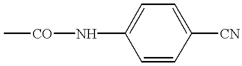 | —O—CH₂—COO—CH₃ |
| I-46 | —CH₂CH₂CH₂CH₂— | | 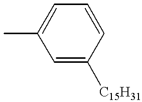 | 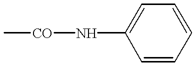 | —Cl |
| I-47 | —C₂H₅ | —C₂H₅ | 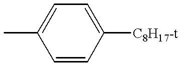 | —CO—O—C₄H₉-i | H |
| I-48 | -phenyl | H | —C₁₂H₂₅ | —CO—CO—N(C₄H₉)₂ | 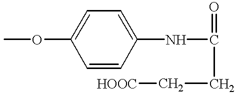 |
| I-49 | —C₁₂H₂₅ | H | 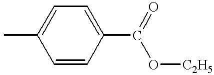 | —CO—CH═CH—CO—N(C₂H₅)₂ | —Cl |
| I-50 | —C₂H₅ | H | 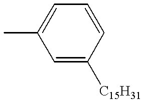 | 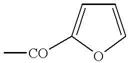 | —Cl |
| I-51 | —C₆H₁₃ | H | 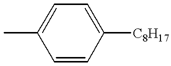 | 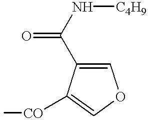 | H |
| I-52 | —C₄H₉ | H | 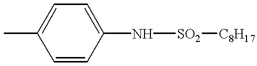 | 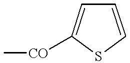 | —Cl |
| I-53 | —CH₃ | H | 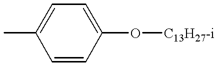 | 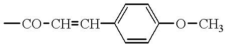 | —Cl |
| I-54 | -phenyl | H | 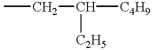 | 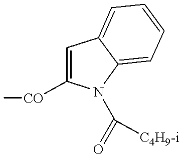 | H |
| I-55 | —C₂H₅ | H | 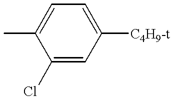 | 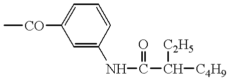 | —Cl |
| I-56 | —C₂H₅ | H | 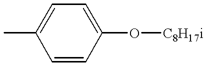 | 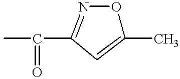 | Cl |
| I-57 | —C₃H₇ | H | 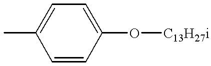 | 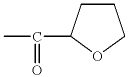 | Cl |
| I-58 | —C₂H₅ | H | 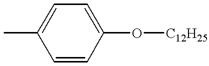 | 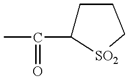 | H |
| I-59 | —H | H | 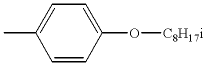 | 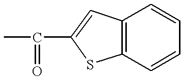 | Cl |
| I-60 | —C₂H₅ | H | 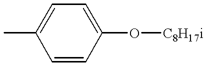 | 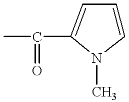 | Cl |

The compounds according to the invention are produced in an analogous manner to the method stated in U.S. Pat. No. 5,686,235.

The compounds of the formula (I) are preferably used in a quantity of 5 to 2000 mg/m², in particular of 10 to 1000 mg/m² and very particularly preferably in a quantity of 20 to 500 mg/m² of the material.

Examples of colour photographic materials are colour negative films, colour reversal films, colour positive films, colour photographic paper, colour reversal photographic paper, colour-sensitive materials for the dye diffusion transfer process or the silver dye bleaching process. A review may be found in Research Disclosure 37038 (1995) and Research Disclosure 38957 (1996).

The photographic materials consist of a support, onto which at least one photosensitive silver halide emulsion layer is applied. Suitable supports are in particular thin films and sheets. A review of support materials and auxiliary layers applied to the front and reverse sides thereof is given in Research Disclosure 37254, part 1 (1995), page 285 and in Research Disclosure 38957, part XV (1996), page 627.

The colour photographic materials conventionally contain at least one red-sensitive, one green-sensitive and one blue-sensitive silver halide emulsion layer, optionally together with interlayers and protective layers.

Depending upon the type of photographic material, these layers may be differently arranged. This is demonstrated for the most important products:

Colour photographic films such as colour negative films and colour reversal films have on the support, in the stated sequence, 2 or 3 red-sensitive, cyan-coupling silver halide emulsion layers, 2 or 3 green-sensitive, magenta-coupling silver halide emulsion layers and 2 or 3 blue-sensitive, yellow-coupling silver halide emulsion layers. The layers of identical spectral sensitivity differ with regard to their photographic sensitivity, wherein the less sensitive sublayers are generally arranged closer to the support than the more highly sensitive sublayers.

A yellow filter layer is conventionally located between the green-sensitive and blue-sensitive layers which prevents blue light from penetrating into the underlying layers.

Possible options for different layer arrangements and the effects thereof on photographic properties are described in J. Inf. Rec. Mats., 1994, volume 22, pages 183-193 and in Research Disclosure 38957, part XI (1996), page 624.

Colour photographic paper, which is usually substantially less photosensitive than a colour photographic film, conventionally has on the support, in the stated sequence, one blue-sensitive, yellow-coupling silver halide emulsion layer, one green-sensitive, magenta-coupling silver halide emulsion layer and one red-sensitive, cyan-coupling silver halide emulsion layer; the yellow filter layer may be omitted.

The number and arrangement of the photosensitive layers may be varied in order to achieve specific results. For example, all high sensitivity layers may be grouped together in one package of layers and all low sensitivity layers may be grouped together in another package of layers in order to increase sensitivity (DE 25 30 645).

The substantial constituents of the photographic emulsion layers are binder, silver halide grains and colour couplers.

Details of suitable binders may be found in Research Disclosure 37254, part 2 (1995), page 286 and in Research Disclosure 38957, part II.A (1996), page 598.

Details of suitable silver halide emulsions, the production, ripening, stabilisation and spectral sensitisation thereof, including suitable spectral sensitisers, may be found in Research Disclosure 37254, part 3 (1995), page 286, in Research Disclosure 37038, part XV (1995), page 89 and in Research Disclosure 38957, part V.A (1996), page 603.

Photographic materials with camera sensitivity conventionally contain silver bromide-iodide emulsions, which may optionally contain small proportions of silver chloride. Photographic print materials contain either silver chloride-bromide emulsions containing up to 80 wt. % of AgBr or silver chloride-bromide emulsions containing above 95 mol % of AgCl.

Details of colour couplers maybe found in Research Disclosure 37254, part 4 (1995), page 288, in Research Disclosure 37038, part II (1995), page 80 and in Research Disclosure 38957, part X.B (1996), page 616. The maximum absorption of the dyes formed from the couplers and the developer oxidation product is preferably within the following ranges: yellow coupler 430 to 460 nm, magenta coupler 540 to 560 nm, cyan coupler 630 to 700 nm.

In order to improve sensitivity, grain, sharpness and colour separation in colour photographic films, compounds are frequently used which, on reaction with the developer oxidation product, release photographically active compounds, for example DIR couplers which eliminate a development inhibitor.

Details relating to such compounds, in particular couplers, may be found in Research Disclosure 37254, part 5 (1995), page 290, in Research Disclosure 37038, part XIV (1995), page 86 and in Research Disclosure 38957, part X.C (1996), page 618.

Colour couplers, which are usually hydrophobic, as well as other hydrophobic constituents of the layers, are conventionally dissolved or dispersed in high-boiling organic solvents. These solutions or dispersions are then emulsified into an aqueous binder solution (conventionally a gelatine solution) and, once the layers have dried, are present as fine droplets (0.05 to 0.8 μm in diameter) in the layers.

Suitable high-boiling organic solvents, methods for the introduction thereof into the layers of a photographic material and further methods for introducing chemical compounds into photographic layers may be found in Research Disclosure 37254, part 6 (1995), page 292.

The non-photosensitive interlayers generally arranged between layers of different spectral sensitivity may contain agents which prevent an undesirable diffusion of developer oxidation products from one photosensitive layer into another photosensitive layer with a different spectral sensitisation.

Suitable compounds (white couplers, scavengers or DOP scavengers) may be found in Research Disclosure 37254, part 7 (1995), page 292, in Research Disclosure 37038, part III (1995), page 84 and in Research Disclosure 38957, part X.D (1996), pages 621 et seq.

The photographic material may also contain UV light absorbing compounds, optical brighteners, spacers, filter dyes, formalin scavengers, light stabilisers, antioxidants, Dₘᵢₙ dyes, plasticisers (latices), biocides and additives to improve coupler and dye stability, to reduce colour fogging and to reduce yellowing, and others. Suitable compounds may be found in Research Disclosure 37254, part 8 (1995), page 292, in Research Disclosure 37038, parts IV, V, VI, VII, X, XI and XIII (1995), pages 84 et seq. and in Research Disclosure 38957, parts VI, VIII, IX and X (1996), pages 607 and 610 et seq.

The layers of colour photographic materials are conventionally hardened, i.e. the binder used, preferably gelatine, is crosslinked by appropriate chemical methods.

Suitable hardener substances may be found in Research Disclosure 37254, part 9 (1995), page 294, in Research Disclosure 37038, part XII (1995), page 86 and in Research Disclosure 38957, part II.B (1996), page 599.

Once exposed with an image, colour photographic materials are processed using different processes depending upon their nature. Details relating to processing methods and the necessary chemicals are disclosed in Research Disclosure 37254, part 10 (1995), page 294, in Research Disclosure 37038, parts XVI to XXIII (1995), pages 95 et seq. and in Research Disclosure 38957, parts XVIII, XIX and XX (1996), pages 630 et seq. together with example materials.

The magenta couplers preferably comprise those having pyrazolotriazole structures of the formulae (II) or (III)

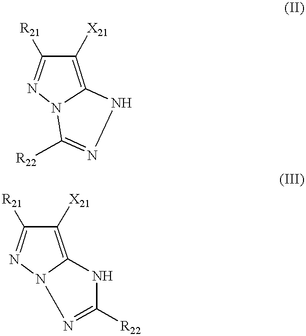

in which

X₂₁ means H or a group eliminable under the conditions of chromogenic development,

R₂₁ means optionally substituted alkyl,

R₂₂ means R₂₁ or aryl,

wherein the sum of all the C atoms of the residues R₂₁ and R₂₂ in one coupler molecule is at least 12.

Examples of suitable couplers are:

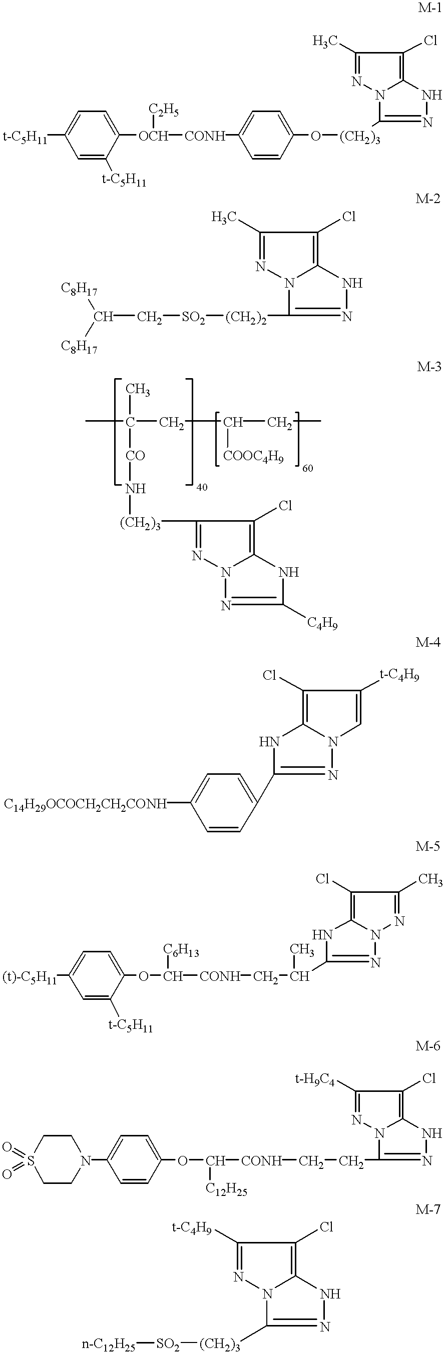

Apart from the cyan couplers of the formula (I) according to the invention, further cyan couplers may be used in the same or in another layer.

Examples of these are:

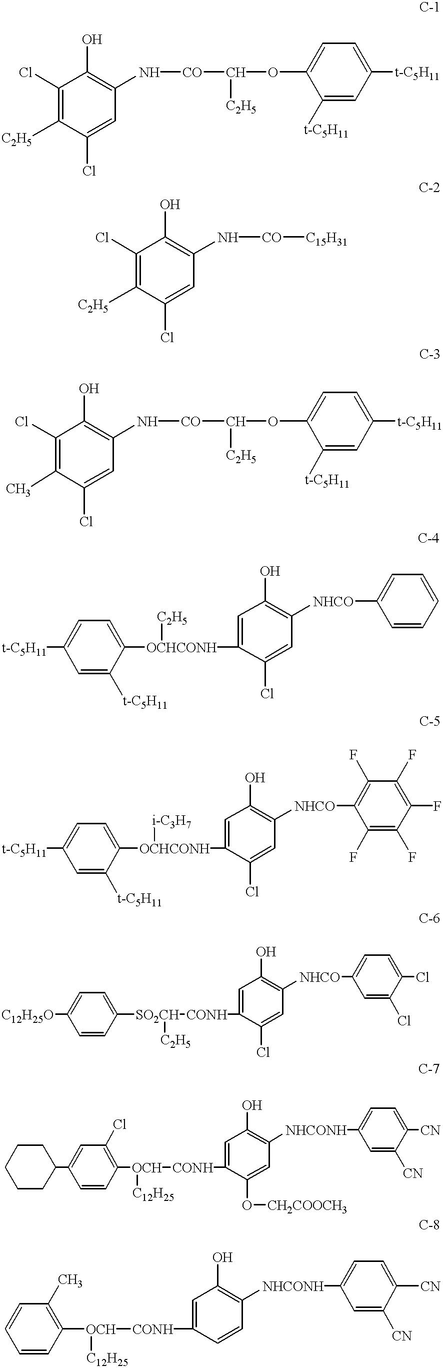

The DOP scavenger preferably comprises benzofuranones of the formula (IV)

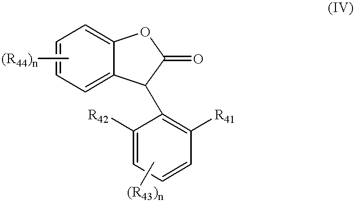

in which

R₄₁ means alkyl, cycloalkyl, aryl, halogen, SR₄₅, NR₄₆R₄₇, nitro, cyano, SO₂R₄₈, COOR₄₉, COR₅₀, hetaryl or hydrogen,

R₄₂ has the same meaning as R₄₁ or means OR₅₂,

R₄₃ and R₄₄ mutually independently mean OR₅₁ or have the meaning of R₄₁,

R₄₅, R₄₉ mutually independently mean alkyl, cycloalkyl, alkenyl, aryl or hetaryl,

R₄₆, R₄₇ mutually independently mean H, R₄₄, COR₅₀, COOR₄₉, SO₂R₄₈,

R₄₈, R₅₀ mutually independently mean alkyl, cycloalkyl, alkenyl, aryl, hetaryl or NR₄₀R₄₇,

R₅₁ means hydrogen, alkyl or aryl,

R₅₂ means hydrogen, alkyl, aryl, alkylcarbonyl, alkenylcarbonyl, arylcarbonyl, alkoxycarbonyl, alkenyloxycarbonyl, carbamoyl, alkylsulfonyl or arylsulfonyl,

o means 0, 1, 2, 3 or 4 and

p means 0, 1, 2, or 3,

wherein two residues R₄₃ or R₄₄ may in each case mean a fused carbo- or heterocyclic ring or the compound of the formula (IV) is attached to a polymer chain via a residue R₄₃ or R₄₄.

Examples of suitable compounds are:

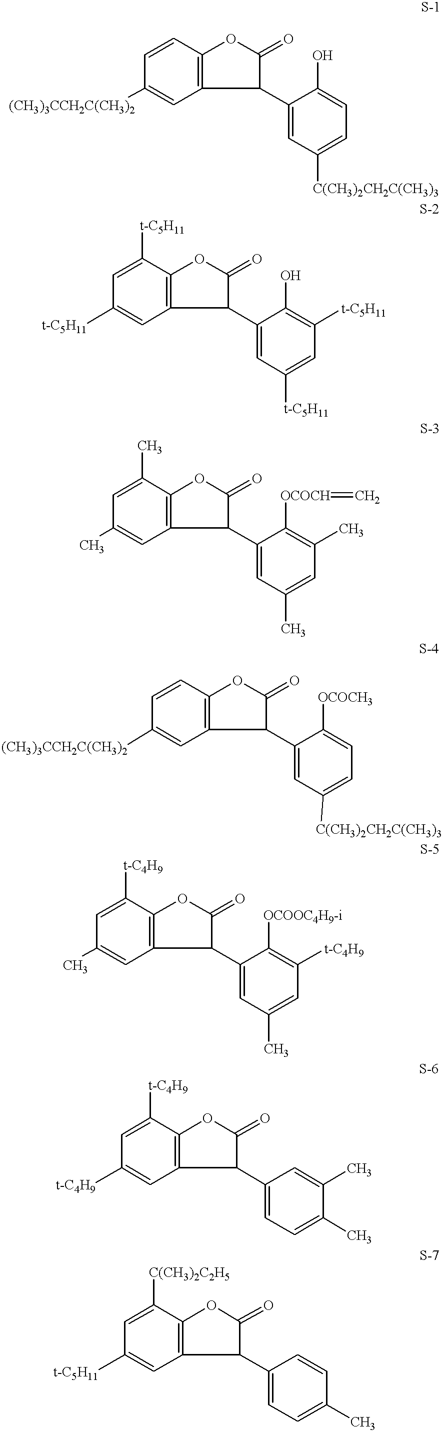

### EXAMPLES

### Example 1

A colour photographic recording material suitable for rapid processing was produced by applying the following layers in the stated sequence onto a layer support of paper coated on both sides with polyethylene. Quantities are stated in each case per 1 m². The silver halide application rate is stated as the corresponding quantities of AgNO₃.

Layer structure 101
Layer 1: (Substrate layer)
0.10 g of gelatine
Layer 2: (Blue-sensitive layer)
Blue-sensitive silver halide emulsion (99.5 mol % chloride, 0.5 mol %
bromide, average grain diameter 0.75 μm) prepared from 0.4 g of
AgNO₃, spectrally sensitised with 0.6 mg of compound BS-1
1.25 g of gelatine
0.30 g of yellow coupler GB-1
0.15 g of yellow coupler GB-2
0.30 g of tricresyl phosphate (TCP)
0.10 g of isooctadecanol
0.05 g of stabiliser ST-1
0.10 g of stabiliser ST-2
Layer 3: (Interlayer)
0.10 g of gelatine
0.08 g of DOP scavenger S-4
0.04 g of DOP scavenger SC-1
0.01 g of DOP scavenger SC-2
0.12 g of TCP
Layer 4: (Green-sensitive layer)
Green-sensitive silver halide emulsion (99.5 mol % chloride, 0.5
mol % bromide, average grain diameter 0.45 μm) prepared from 0.2 g
of AgNO₃, spectrally sensitised with 0.12 mg of compound GS-1
1.10 g of gelatine
0.10 g of magenta coupler M-7
0.10 g of magenta coupler M-4
0.15 g of stabiliser ST-3
0.20 g of stabiliser ST-4
0.20 g of TCP
0.20 g of isotetradecanol
0.20 g of tris(2-ethylhexyl) phosphate
Layer 5 (UV protective layer)
1.05 g of gelatine
0.20 g of UV absorber UV-1
0.10 g of UV absorber UV-2
0.05 g of UV absorber UV-3
0.08 g of DOP scavenger S-4
0.04 g of DOP scavenger SC-1
0.01 g of DOP scavenger SC-2
0.15 g of TCP
0.15 g of tris(2-ethylhexyl) phosphate
Layer 6: (Red-sensitive layer)
Red-sensitive silver halide emulsion (99.5 mol % chloride, 0.5 mol %
bromide, average grain diameter 0.48 μm) prepared from 0.28 g of
AgNO₃, spectrally sensitised with 0.04 mg of compound RS-1 and
stabilised with 0.56 mg of stabiliser ST-5
1.00 g of gelatine
0.10 g of cyan coupler C-1
0.30 g of cyan coupler C-2
0.20 g of dibutyl phthalate (DBP)
0.20 g of TCP
0.10 g of stabiliser ST-6
Layer 7 (UV protective layer)
1.05 g of gelatine
0.10 g of UV absorber UV-1
0.30 g of UV absorber UV-2
0.05 g of UV absorber UV-3
0.20 g of tris(2-ethylhexyl) phosphate
Layer 8 (Protective layer)
0.90 g of gelatine
0.05 g of optical brightener W-1
0.07 g of polyvinylpyrrolidone
1.20 mg of silicone oil
2.50 mg of polymethyl methacrylate spacers, average particle size 0.8 μm
0.30 g of instant hardener H-1

The following compounds are used in Example 1:

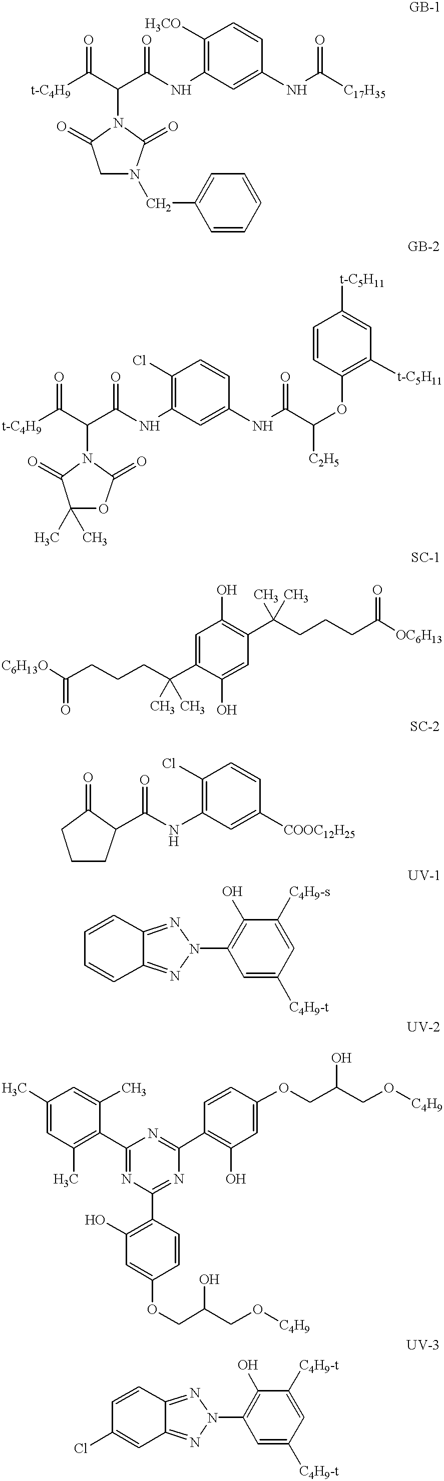

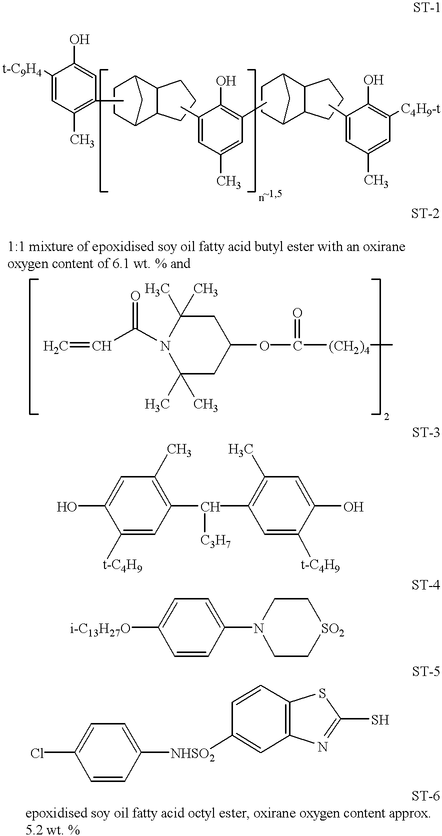

[chemical structure]

Processing:

Samples of the material are exposed under a grey wedge through a red filter and processed as follows:

| | | |
|---|---|---|
| a) | Colour developer - 45 s - 35° C. | |
| | Triethanolamine | 9.0 g |
| | N,N-Diethylhydroxylamine | 2.0 g |
| | Bis(2-sulfoethyl)hydroxylamine disodium salt | 2.0 g |
| | Diethylene glycol | 0.05 g |
| | 3-Methyl-4-amino-N-ethyl-N-methane- | |
| | sulfonamidoethylaniline sulfate | 5.0 g |
| | Potassium sulfite | 0.2 g |
| | Triethylene glycol | 0.05 g |
| | Potassium carbonate | 22 g |
| | Potassium hydroxide | 0.4 g |
| | Ethylenediaminetetraacetic acid, disodium salt | 2.2 g |
| | Potassium chloride | 2.5 g |
| | 1,2-Dihydroxybenzene-3,4,6-trisulfonic acid | |
| | trisodium salt | 0.3 g |
| | make up with water to 1000 ml; pH 10.0 | |
| b) | Bleach/fixing bath - 45 s - 35° C. | |
| | Ammonium thiosulfate | 75 g |
| | Sodium hydrogen sulfite | 13.5 g |
| | Ammonium acetate | 2.0 g |
| | Ethylenediaminetetraacetic acid | |
| | (iron/ammonium salt) | 57 g |
| | Ammonia, 25% | 9.5 g |
| | make up with acetic acid to 1000 ml; pH 5.5 | |
| c) | Rinsing - 2 min - 33° C. | |
| d) | Drying | |

The percentage yellow and magenta secondary densities were then determined at cyan density D_{cyan}=1.0 (SD_{yellow}, SD_{magenta}). The results are shown in Table 1. The samples are also stored in darkness for 42 days at 85° C. and 60% relative humidity and the percentage reductions in density at maximum density (ΔDₘₐₓ) were determined. Further samples are exposed to 15·10⁶ lux·h of light from a daylight-standardised xenon lamp at 35° C. and 85% relative humidity. The reduction in density at D=0.6 is then determined [ΔD_{0.6}].

The following oil formers are also used in the other samples:

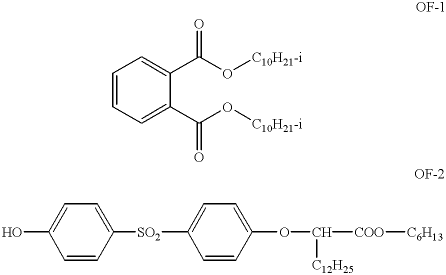

TABLE 1
(C: comparison; I: according to the invention)

| | | | | | | Light |
|---|---|---|---|---|---|---|
| | | | Secondary density | | Dark | stability |
| | Layer 6 | | (%) | | stability | (%) |
| Layer | Cyan | Oil | SD | SD | ΔDₘₐₓ | ΔD_{1.0} |
| structure | coupler | former | yellow | magenta | (%) | (%) |
| 101(C) | C-1/C-2 | DBP/TCP | 11.8 | 28.3 | −37 | −27 |
| | (1:3) | (1:1) | | | | |
| 102(C) | CA | DBP/OF-1 | 12.7 | 37.9 | −4 | −36 |
| | (1:3) | (1:1) | | | | |
| 103(C) | C-13 | TCP/OF-2 | 9.9 | 27.8 | −13 | −78 |
| | | (1:3) | | | | |
| 104(C) | C-17 | DBP/OF-1 | 9.6 | 31.4 | −7 | −31 |
| | | (1:1) | | | | |
| 105(I) | 1-2 | DBP/TCP | 9.8 | 24.2 | −9 | −32 |
| | | (1:1) | | | | |
| 106(I) | 1-26 | TCP | 9.5 | 25.3 | −7 | −29 |
| 107(I) | 1-32 | DBP/TCP | 9.9 | 23.7 | −10 | −39 |
| | | (1:1) | | | | |
| 108(I) | 1-33 | TCP/DBP | 9.4 | 26.2 | −6 | −31 |
| | | (2:1) | | | | |
| 109(I) | 1-38 | TCP | 9.7 | 27.1 | −10 | −28 |
| 110(I) | 1-53 | TCP | 9.3 | 25.8 | −7 | −27 |
| 111(I) | 1-56 | TCP/DBP | 9.8 | 24.7 | −8 | −32 |
| | | (2:1) | | | | |
| 112(I) | 1-57 | TCP | 9.9 | 26.4 | −11 | −28 |

In comparison with conventional phenolic cyan couplers (C-1 and C-2), conventional diacylaminophenol cyan couplers (C-4), heterocyclic cyan couplers (C-13) and the special diacylaminophenol cyan couplers according to U.S. Pat. No. 5,686,235 (C-17), only the couplers according to the invention yield dyes which are simultaneously distinguished by good light stability, outstanding dark stability and good colour reproduction.

1. Colour photographic silver halide material having a support and at least one photosensitive silver halide emulsion layer which is associated with a cyan coupler of the formula (I): 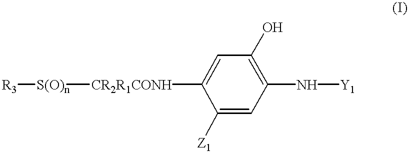
in which
R₁, R₂ mean H, alkyl, alkenyl, aryl or hetaryl,
R₃ means alkyl, alkenyl, aryl or hetaryl,
Z₁ means H or a group eliminable under the conditions of chromogenic development,
Y₁ means —COR₄, —CO₂R₄, —CONR₄R₅, —SO₂R₄, —SO₂NR₄R₅, —CO—CO₂R₄, —COCONR₄R₅ or a group of the formula 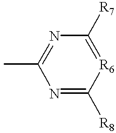
R₄ means alkyl, alkenyl, aryl or hetaryl,
R₅ means H or R₄,
R₆ means —N═ or —C(R₉)═
R₇, R₈, R₉ mean —OR₅, —SR₅, —NR₄R₅, —R₅ or Cl and
n means 1 or 2.

2. Colour photographic silver halide material according to claim 1, characterised in that n means 1.

3. Colour photographic silver halide material according to claim 1, characterised in that
n means 2,
Y₁ means —CO—Y₁₁ and
Y₁₁ means alkenyl or hetaryl.

4. Colour photographic silver halide material according to claim 1, characterised in that
n means 2,
Y₁ means —SO₂R₁₀, —SO₂N(R₁₀)₂, —CO₂R₁₀, —COCO₂R₁₀ or —COCON(R₁₀)₂ and
R₁₀ means alkyl, aryl, alkenyl or hetaryl.

5. Colour photographic material according to claim 1, characterised in that
n means 2 and
Y means

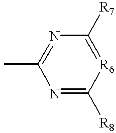

6. Colour photograhic material according to claim 1, characterised in that
n means 2 and
Y₁ means a residue of the formula 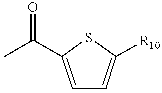
wherein
R₁₀ means H, Cl, CN, Br, F, alkylcarbonyl, arylcarbonyl, alkylaminocarbonyl, arylaminocarbonyl, alkoxycarbonyl or aryloxycarbonyl

7. Colour photographic material according to any one of claims 1 to 6, characterised in that
R₁, R₂ mean H, alkyl, aryl,
R₃ means alkyl, aryl,
Z₁ means H, Cl, alkoxy, aryloxy, alkylthio, arylthio,
R₆ means —N═
R₇, R₈ mean —OR₅, —NR₄R₅ or Cl.

8. Colour photographic material according to claim 1, characterised in that the compounds of the formula (I) are used in a quantity of 5 to 2000 mg/m².

9. Colour photographic material according to claim 1, characterised in that the material contains a magenta coupler of the formulae (II) or (III): 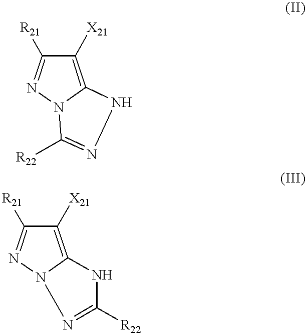
in which
X₂₁ means H or a group eliminable under the conditions of chromogenic development,
R₂₁ means optionally substituted alkyl,
R₂₂ means R₂₁ or aryl,
wherein the sum of all the C atoms of the residues R₂₁ and R₂₂ in one coupler molecule is at least 12.

10. Colour photographic silver halide material according to claim 1, characterised in that the material contains a DOP scavenger of the formula (IV): 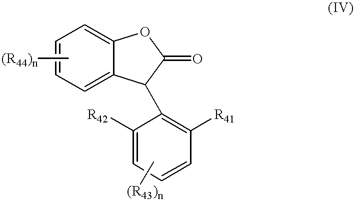
in which
R₄₁ mutually independently means alkyl, cycloalkyl, aryl, halogen, SR₄₅, NR₄₆R₄₇, nitro, cyano, SO₂R₄₈, COOR₄₉, COR₅₀, hetaryl or hydrogen,
R₄₂ has the same meaning as R₄₁ or means OR₅₂,
R₄₃ and R₄₄ mutually independently mean OR₅₁ or have the meaning of R₄₁,
R₄₅, R₄₉ mutually independently mean alkyl, cycloalkyl, alkenyl, aryl or hetaryl,
R₄₆, R₄₇ mutually independently mean H, R₄₄, COR₅₀, COOR₄₉, SO₂R₄₈,
R₄₈, R₅₀ mutually independently mean alkyl, cycloalkyl, alkenyl, aryl, hetaryl or NR₄₀R₄₇,
R₅₁ means hydrogen, alkyl or aryl,
R₅₂ means hydrogen, alkyl, aryl, alkylcarbonyl, alkenylcarbonyl, arylcarbonyl, alkoxycarbonyl, alkenyloxycarbonyl, carbamoyl, alkylsulfonyl or arylsulfonyl,
o means 0, 1, 2, 3 or 4 and
p means 0, 1, 2, or 3,
wherein two residues R₄₃ or R₄₄ may in each case mean a fused carbo- or heterocyclic ring or the compound of the formula (IV) is attached to a polymer chain via a residue R₄₃ or R₄₄.
